(19) United States
(12) Patent Application Publication
(10) Pub. No.: US 2025/0203718 A1
(43) Pub. Date: Jun. 19, 2025

(54) SHEET-LIKE HEATER

(71) Applicant: TOMOEGAWA CORPORATION, Tokyo (JP)

(72) Inventors: Makoto GOTO, Shizuoka-shi (JP); Yosuke SUGAWARA, Shizuoka-shi. Shizuoka (JP); Taku KURAHARA, Shizuoka-shi (JP)

(21) Appl. No.: 18/848,060

(22) PCT Filed: Mar. 2, 2023
(86) PCT No.: PCT/JP2023/007892

§ 371 Date: Sep. 17, 2024

(30) Foreign Application Priority Data
Mar. 31, 2022 (JP) 2022-058697

(51) Int. Cl. H05B 3/06; H05B 3/03; H05B 3/28; H05B 3/38

(52) U.S. Cl. CPC H05B 3/06; H05B 3/03; H05B 3/286; H05B 3/38; H05B 2203/006; H05B 2203/016; H05B 2203/017

(57) ABSTRACT

Aimed at achieving reliable joining between a heat element and an electrode, and high flexibility, provided as a solution is a sheet-like heater having an electrode area in which the electrode, a joining aid, and a porous heat element are stacked in this order, and the electrode area has at least one joined part in which the electrode, the joining aid and the porous heat element are joined.

### CROSS REFERENCE TO RELATED APPLICATIONS

This application is a 371 U.S. National Phase of International Application No. PCT/JP2023/007892, filed on Mar. 2, 2023, which claims priority to Japanese Patent Application No. 2022-058697, filed Mar. 31, 2022. The entire disclosures of the above applications are incorporated herein by reference.

### TECHNICAL FIELD

This invention relates to a sheet-like heater.

### BACKGROUND ART

Several types of sheet-like heater have been proposed.

For example, JP 3127850 U discloses a sheet heater that includes a plurality of heat elements formed of thin stainless steel sheet, arranged in parallel, and an insulating base stacked on at least either face of these heat elements, in which each heat element has a power input terminal tightly joined to one end thereof, and has a connection part for connection with the adjacent heat element formed at the other end thereof, the connection part having a brazing material and a terminal piece stacked therein, with the power input terminal tightly joined to the end of each heat element while placing the electroconductive brazing material in between.

A heater for heating an object to be heated, having a curved face such as pipe, is necessarily flexible so as to make it conformable to the object to be heated. Another requirement is that the heat element and the electrode of the heater remain tightly joined, even under an external force such as vibration or agitation applied to a joined part. Excessive tightness of joining between the heat element and the electrode has, however, reduced the flexibility of the heater in some cases.

It is therefore an object of this invention to provide a sheet-like heater in which the heat element and the electrode are tightly joined, but excels in flexibility.

### SUMMARY

This invention encompasses items (1) to (11) below.
(1) A sheet-like heater having a sheet-like porous heat element, the sheet-like heater including:
an electrode present on at least one main face of the porous heat element; and
at least one joined part formed of the porous heat element and the electrode which are at least partially melted under heating and then allowed to solidify, whereby the joined part electrically connects the porous heat element and the electrode.
(2) The sheet-like heater according to (1), including:
a first insulating layer;
the sheet-like porous heat element; and
a second insulating layer, which are stacked in this order, and
at least a part of the electrode is not covered with the first insulating layer and the second insulating layer.
(3) The sheet-like heater according to (1) or (2), further including a joining aid between the porous heat element and the electrode, wherein
the joined part is formed of the porous heat element, the joining aid and the electrode which are at least partially melted under heating and then allowed to solidify, whereby the joined part electrically connects the porous heat element, the joining aid and the electrode.
(4) The sheet-like heater according to (3), further including a reinforcing member on the main face of the porous heat element on the side having no electrode present thereon, wherein
the joined part is formed of the reinforcing member, the porous heat element, the joining aid and the electrode which are at least partially melted under heating and then allowed to solidify, whereby the joined part electrically connects the reinforcing member, the porous heat element, the joining aid and the electrode.
(5) The sheet-like heater according to (1) or (2), further including a reinforcing member on the main face of the porous heat element on the side having no electrode present thereon, wherein
the joined part is formed of the reinforcing member, the porous heat element and the electrode which are at least partially melted under heating and then allowed to solidify.
(6) The sheet-like heater according to any one of (1) to (5), having a plurality of the joined parts per electrode.
(7) The sheet-like heater according to any one of (1) to (6), wherein the joined part has a dot shape and/or a line shape, when the main face is viewed from the side the electrode is present.
(8) The sheet-like heater according to any one of (1) to (7), wherein the electrode and the porous heat element are formed of the same kind of metal.
(9) The sheet-like heater according to any one of (1) to (7), wherein the electrode and the porous heat element are formed of different kinds of metal.
(10) The sheet-like heater according to any one of (1) to (9), wherein the electrode contains a metal fiber.
(11) The sheet-like heater according to any one of (1) to (10), wherein the porous heat element contains a metal fiber.

### Advantageous Effects of Invention

This invention can provide a sheet-like heater in which the heat element and the electrode are tightly joined, but excels in flexibility.

### BRIEF DESCRIPTION OF THE DRAWINGS

FIG. 1 is a drawing (schematic drawing) illustrating a sheet-like heater 1a of this invention in Embodiment 1, viewed in a direction of a perpendicular line on the main face thereof.

FIG. 2 is a cross-sectional view (schematic drawing) taken along line A-A in FIG. 1.

FIG. 3 is a cross-sectional view (schematic drawing) taken along line B-B in FIG. 1.

FIG. 4 is a cross-sectional view (schematic drawing) taken along line C-C in FIG. 1.

FIG. 5 is a cross-sectional view of a sheet-like heater 1b of this invention in Embodiment 2, taken in a direction parallel to a perpendicular line on the main face thereof.

FIG. 6 is a SEM image of a cross section of a joined part and the periphery in Embodiment 2, observed under a scanning electron microscope (SEM).

FIG. 7 is a drawing (schematic drawing) of a sheet-like heater 1c of this invention in Embodiment 3, viewed in the direction of a perpendicular line on the main face thereof.

FIG. 8 is a cross-sectional view (schematic drawing) taken along line D-D in FIG. 7.

FIG. 9 is a cross-sectional view (schematic drawing) taken along line E-E in FIG. 7.

FIG. 10 is a cross-sectional view (schematic drawing) taken along line F-F in FIG. 7.

FIG. 11 is a drawing (schematic drawing) of a sheet-like heater 1d of this invention in Embodiment 4, viewed in the direction of a perpendicular line on the main face thereof.

FIG. 12 is a drawing (schematic drawing) of a sheet-like heater 1e of this invention in Embodiment 5, viewed in the direction of a perpendicular line on the main face thereof.

FIG. 13 is a drawing (schematic drawing) of a sheet-like heater 1f of this invention in Embodiment 6, viewed in the direction of a perpendicular line on the main face thereof.

FIG. 14 is a drawing illustrating a method for manufacturing the sheet-like heater in Embodiment 2.

FIG. 15 is another drawing illustrating a method for manufacturing the sheet-like heater in Embodiment 2.

### DETAILED DESCRIPTION

This invention will be explained.

A sheet-like heater of this invention has a sheet-like porous heat element, the sheet-like heater includes: an electrode present on at least one main face of the porous heat element; and a joined part formed of the porous heat element and the electrode which are at least partially melted under heating and then allowed to solidify, whereby the joined part electrically connects the porous heat element and the electrode.

Embodiments of the sheet-like heater of this invention will be explained while referring to the attached drawings.

Note that the Embodiments explained below are preferred examples of the sheet-like heater of this invention, to which this invention is by no means limited. Also sizes and shapes seen in the drawings are merely illustrative, to which this invention is by no means limited.

### EMBODIMENTS

### Embodiment 1

Embodiment 1 of the sheet-like heater of this invention will be explained while referring to the attached drawings.

Embodiment 1 relates to a sheet-like heater having a sheet-like porous heat element, the sheet-like heater having:
a first insulating layer;
the sheet-like porous heat element; and
a second insulating layer, which are stacked in this order,
wherein,
an electrode is present on at least one main face of the porous heat element,
a joining aid is further provided between the porous heat element and the electrode,
at least a part of the electrode is not covered with the first insulating layer and the second insulating layer, and
the sheet-like heater has a joined part formed of the porous heat element, the joining aid and the electrode which are at least partially melted under heating and then allowed to solidify, whereby the joined part electrically connects the porous heat element, the joining aid and the electrode.

That is, Embodiment 1 is a preferred embodiment of a sheet-like heater of this invention, further having the first insulating layer, the second insulating layer and the joining aid.

The joined part in this case is formed of at least a part of the porous heat element, at least a part of the joining aid, and at least a part of the electrode which are melted under heating, and then allowed to solidify.

The porous heat element, the joining aid, and the electrode are electrically connected through the joined part.

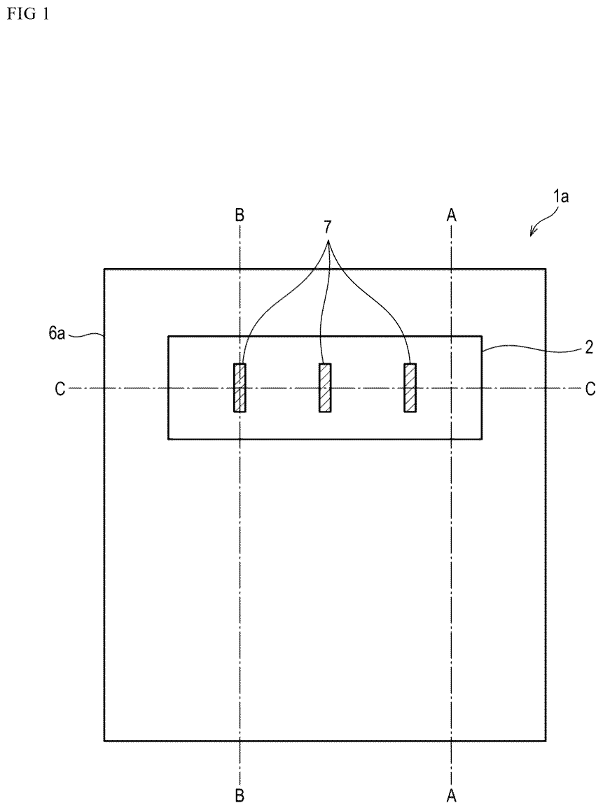

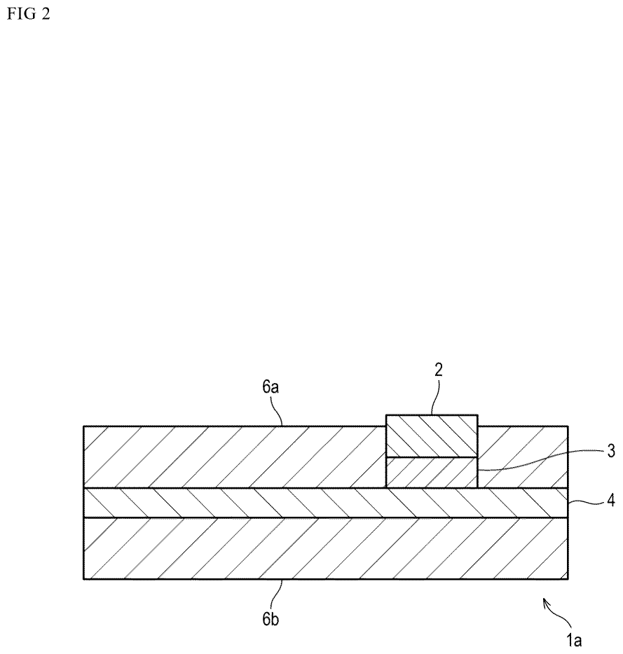

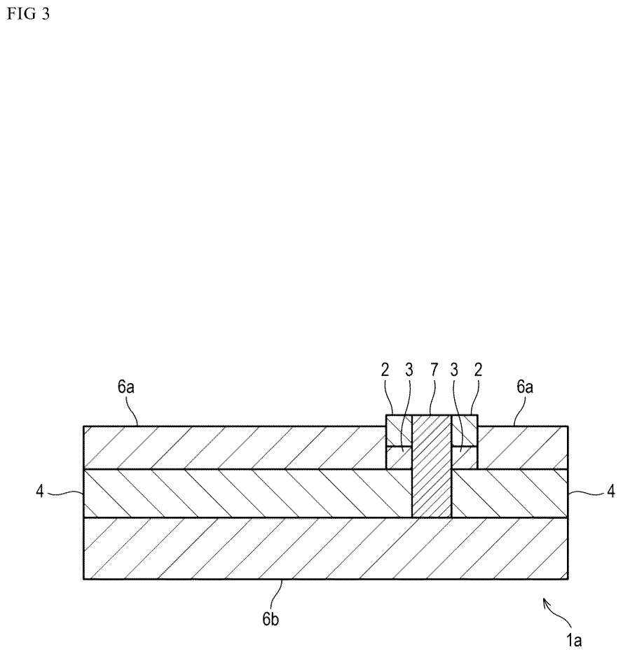

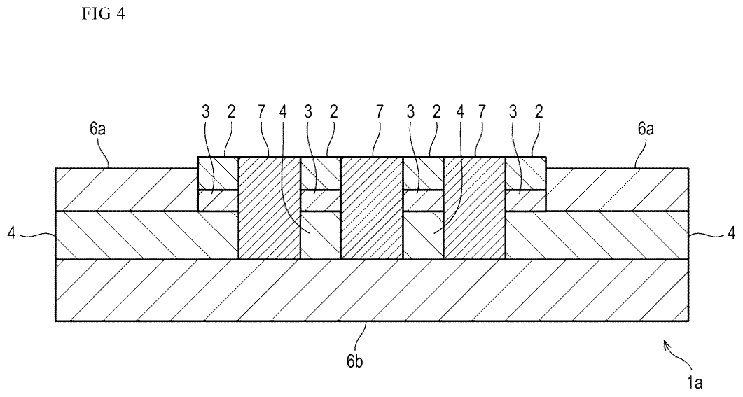

FIG. 1 is a drawing (schematic drawing) illustrating a sheet-like heater 1a of this invention in Embodiment 1, viewed in a direction of a perpendicular line on the main face thereof. FIG. 2 is a cross-sectional view (schematic drawing) taken along line A-A in FIG. 1; FIG. 3 is a cross-sectional view (schematic drawing) taken along line B-B in FIG. 1; and FIG. 4 is a cross-sectional view (schematic drawing) taken along line C-C in FIG. 1. All of FIGS. 2 to 4 represent cross-sections taken in a direction parallel to the perpendicular line on the main face of the sheet-like heater 1a of this invention.

Note that in the sheet-like heater of this invention that involves Embodiment 1 and other Embodiments described later, the mode of stacking may be confirmed by observing the cross sections that correspond to FIGS. 2 to 4, under an optical microscope or a scanning electron microscope.

As illustrated in FIGS. 1 to 4, the sheet-like heater 1a of this invention in Embodiment 1 has a first insulating layer 6a, a sheet-like porous heat element 4, and a second insulating layer 6b stacked in this order.

On one main face of the porous heat element 4, an electrode 2 is present while placing a joining aid 3 in between.

The electrode 2 in this invention, although present on at least one main face of the porous heat element 4 as seen above, is not always necessarily in contact with the main face of the porous heat element 4. The electrode may resides, as in Embodiment 1, on the main face of the porous heat element 4 while placing the joining aid 3 in between.

Now, at least a part of the electrode 2 is not covered with the first insulating layer 6a and the second insulating layer 6b. That is, the outer face of the electrode 2 is at least partially exposed. In the sheet-like heater 1a of this invention in Embodiment 1, the outer face of the electrode is exposed to the surface as illustrated in FIGS. 1 and 4.

The sheet-like heater 1a of this invention in Embodiment 1 has three joined parts 7 and one electrode 2, as illustrated in FIGS. 1 to 4.

Each joined part 7 is formed of at least a part of the porous heat element 4, at least a part of the joining aid 3, and at least a part of the electrode 2, which are melted under heating and then allowed to solidify.

For example, by placing the electrode 2 on the main face of the porous heat element 4 while placing the joining aid 3 in between, and by welding the electrode 2 under a welding rod pressed on the surface thereof, at least a part of each of the electrode 2, the joining aid 3 and the porous heat element 4 are melted by the heat. After being allowed to cool and solidify, the melted parts will form the joined part 7.

The porous heat element 4, the joining aid 3, and the electrode 2 are electrically connected through the joined part 7.

Although the porous heat element 4, the joining aid 3 and the electrode 2 may be formed of different metals, they are preferably formed of the same metal. This is because the resultant joined part 7 tends to have higher strength, if the porous heat element 4, the joining aid 3 and the electrode 2 are formed of the same metal.

Note that the same metal herein means that the major element is the same.

The major element means a set of one or more elements whose total content (mol %) exceeds 90 mol %, when calculated by adding the content(s) (mol %) of the element(s) that constitute(s) the metal in the order from the most abundant element to the scarcest element. If the content of one element accounts for 90 mol % or more, then the major element is such one element only.

As described above, the sheet-like heater 1a of this invention in Embodiment 1 has three joined parts 7.

In the sheet-like heater of this invention that involves Embodiment 1 and other Embodiments described later, a plurality of joined parts 7 are preferably provided per electrode 2. More specifically, the sheet-like heater of this invention preferably has 2 to 20 joined parts per electrode, and more preferably has 3 to 15 joined parts.

This is because, with the plurality of joined parts provided per electrode, the sheet-like heater of this invention will have the electrode and the porous heat element more tightly joined, and will have improved flexibility.

In the sheet-like heater of this invention that involves Embodiment 1 and other Embodiments described later, all of the plurality of joined parts, if owned by the sheet-like heater of this invention, may have the same size, shape or the like, or different ones.

In a case where the sheet-like heater of this invention has a plurality of joined parts per electrode, the joined parts may be localized in the electrode, or may preferably be distributed, while orderly maintaining a constant spacing.

In the sheet-like heater of this invention that involves Embodiment 1 and other Embodiments described later, the joined part preferably has a dot shape and/or a line shape, when the main face of the sheet-like heater of this invention is viewed from the side the electrode is present. Note that the joined part may alternatively have a shape which is not dot or line, such as a plane.

When the main face of the sheet-like heater of this invention is viewed from the side the electrode is present, the joined part preferably looks linear. This is because the joining between the electrode 2 and the porous heat element 4 will be strengthened, and the sheet-like heater of this invention will have improved flexibility under bending.

Each joined part 7 owned by the sheet-like heater 1a of this invention in Embodiment 1 has a linear shape as illustrated in FIG. 1, when the main face is viewed from the side the electrode is present.

The porous heat element 4 will be explained.

The sheet-like heater of this invention contains the sheet-like porous heat element as an essential element.

Note that the following description regarding the porous heat element 4 applies not only to the porous heat element 4 contained in the sheet-like heater 1a of this invention in Embodiment 1, but also to the porous heat elements owned by the sheet-like heaters of this invention in other Embodiments described later.

The porous heat element 4 may only be a porous matter that generates heat upon being energized.

Material for the porous heat element 4 is not specifically limited so far as it can generate heat upon being energized, and is preferably stainless steel (SUS304, SUS316 or SUS316L, for example), which may alternatively be Cu (copper), Al (aluminum), Ni (nickel), nichrome or carbon.

The porous heat element 4 is preferably formed of a fibrous material.

The porous heat element 4 formed of the fibrous material may be, for example, sheet-like metal mesh having linear fibers arranged therein near orthogonally, metal fiber nonwoven fabric having metal fibers arranged therein randomly, metal fiber woven fabric, linear metal fiber, and tape-like metal fiber.

More specifically, the metal mesh is exemplified by a 200- to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

It is preferred that the porous heat element 4 is mainly formed of the metal fiber, and more preferably formed of the metal fiber only.

Now, “mainly formed of” herein means that the content accounts for 70% by mass or more. That is, the metal fiber preferably accounts for 70% by mass or more of the porous heat element 4. The percentage of the metal fiber contained in the porous heat element 4 is preferably 80% by mass or more, more preferably 90% by mass or more, even more preferably 95% by mass or more, and yet more preferably 98% by mass or more.

With the content of the metal fiber in the porous heat element 4 adjusted within the aforementioned ranges, the porous heat element 4 will fully demonstrate the electric conductivity and pyrogenicity.

Note that the percentage of the metal fiber contained in the porous heat element 4 is determined by the following method.

First, a SEM image of the surface of the porous heat element 4, observed at 1000-fold magnification under a scanning electron microscope, is acquired.

Next, a 90 μm×120 μm field of view in the SEM image is subjected to EDS analysis to identify the presence and the type of the metal fiber, and further subjected to image analysis to determine percentage of area occupied by the metal fiber (excluding voids) in the field of view.

The obtained percentage is raised to the power of 3/2 to be converted into volume ratio, which is further multiplied by a true specific gravity of the metal fiber, to find the mass ratio. The content ratio of the metal fiber is thus determined.

In a case where two or more kinds of metal fiber are contained, the percentage of the metal fiber contained in the porous heat element 4 is given by a value determined by adding the content ratios of the individual metal fibers.

The metal fiber is preferably a metallic fiber whose cross section has an equivalent circle diameter of 2 to 100 μm (preferably 5 to 20 μm), and whose length is 2 to 20 mm.

The porous heat element 4 is preferably a metal fiber nonwoven fabric having such metallic fiber randomly arranged therein (also referred to as metal fiber sheet, hereinafter).

The metal fiber sheet may be formed solely of the metal fiber possibly with some voids, or may contain, besides the metal fiber, any material other than the metal fiber (for example, resin fiber that functions as a binder), so far as the pyrogenicity will not be adversely affected.

The binder is exemplified by carbon, glass and silicone resin.

Now the metal fibers that compose the metal fiber sheet are preferably connected at a contact point, at least to a degree that allows current to flow therethrough. For example, the metal fibers are preferably sintered at high temperatures so as to be partially melted, and then allowed to solidify, thereby being fused at the contact point.

The metal fiber sheet is preferably a stainless steel fiber sheet for its excellent heat resistance and chemical resistance. The stainless steel fiber sheet is exemplified by Tommy Filec SS, from Tomoegawa Corporation.

The metal fiber sheet preferably has a basis weight of 25 g/m² or larger, which is preferably 50 g/m² or larger. Meanwhile, the metal fiber sheet has a basis weight of 1000 g/m² or smaller, which is more preferably 200 g/m² or smaller.

With the basis weight of the metal fiber sheet adjusted to 25 g/m² to 1000 g/m², the metal fiber sheet may have a necessary level of strength, and may make the contact point of the metal fibers relatively uniform. Hence, the sheet-like heater, with use of such metal fiber sheet as the porous heat element, can join the porous heat element and the electrode more tightly, while keeping excellent flexibility.

The basis weight herein is determined by image observation under an optical microscope, from which the volume per unit area of the metal fiber sheet is estimated, and then by estimating the weight referring to the specific gravity.

The metal fiber sheet preferably has a density of 1.0 to 5.0 g/cm³, which is more preferably 1.4 to 2.0 g/cm³, and even more preferably approx. 1.7 g/cm³.

The density of the metal fiber sheet herein is defined as a value calculated by:

$$Density ( g / {cm}^{3} ) = Basis weight ( g / {m}^{2} ) / ( Thickness ( mm ) \times 1000 ) ,$$

in accordance with JIS P8118.

With the density adjusted to 1.0 to 5.0 g/cm³, the metal fiber sheet can keep a necessary strength, and can make the contact points among the metal fibers relatively uniform. Hence, the sheet-like heater with use of such metal fiber sheet as the porous heat element will have the porous heat element and the electrode more tightly joined, while keeping excellent flexibility.

The metal fiber sheet is manufacturable either by dry process for manufacturing nonwoven fabric, or by wet sheet forming. When manufactured by the wet sheet forming, numerous metallic fibers, whose cross section has an equivalent circle diameter of 2 to 100 μm, and whose length is 2 to 20 mm, are stirred in a dispersion medium (water, organic solvent, etc.), to which an organic flocculant is added, formed into a sheet typically with use of a square sheet forming machine (typically from Toyo Seiki Seisaku-sho, Ltd.), and formed into a dry sheet having a basis weight of 50 to 1100 g/m², with use of a ferrotype drier. The dry sheet is further sintered at 400 to 1300° C., to obtain the metal fiber sheet.

The porous heat element 4 preferably has a specific electric resistance of 5 to 3000 μΩ·cm, which is more preferably 10 to 2500 μΩ·cm.

Note the specific electric resistance of the porous heat element 4 herein is determined in accordance with JIS K7194.

The porous heat element 4 preferably has a thickness of 10 to 600 μm, which is more preferably 20 to 150 μm. With use of the porous heat element 4 having a thickness of 10 to 600 μm, the sheet-like heater will have the porous heat element and the electrode more tightly joined, while keeping excellent flexibility.

The thickness of the porous heat element 4 herein is determined as follows.

First, a cross section of the sheet-like heater of this invention, taken in a direction parallel to a perpendicular line on the main face thereof, is obtained.

The cross section corresponds to FIGS. 2 to 4.

Next, an enlarged photograph (200-fold magnification) of the cross section is acquired with use of an optical microscope, the thickness of porous heat element 4 is measured on the enlarged photograph at randomly selected 100 points, and a simple average value of the measured thicknesses is determined.

The thus obtained simple average value is employed as the thickness of the porous heat element 4.

Note that also the thickness of any elements owned by the sheet-like heater of this invention, other than the porous heat element 4, will be determined by a similar method.

Shape and size of the porous heat element 4 are properly adjustable in accordance with the shape and size of an object to be heated.

The electrode 2 will be explained.

The sheet-like heater of this invention has the electrode on at least one main face of the sheet-like porous heat element 4. As described previously, the electrode 2 does not necessarily contact with the main face of the porous heat element 4, and for example may reside on the main face of the porous heat element 4 while placing the joining aid in between.

Note that the description below for the electrode 2 applies not only to the electrode 2 contained in the sheet-like heater 1a of this invention in Embodiment 1, but also to the electrodes owned by the sheet-like heaters of this invention that involve other Embodiments described later.

The electrode 2 may only have a mode that can be connected with an external power source, and can feed therethrough electricity fed from the external power source to the porous heat element 4.

Material for the electrode 2 is not specifically limited. The material may be Cu (copper), Ag (silver), Au (gold) and so forth, and preferably stainless steel (SUS304, SUS316 or SUS316L, for example).

The electrode 2 may be formed, for example, of metal foil, sheet-like metal mesh having linear fibers arranged therein near orthogonally, metal fiber nonwoven fabric having metal fibers arranged therein randomly, metal fiber woven fabric, linear metal fiber, and tape-like metal fiber.

More specifically, the metal mesh is exemplified by a 200- to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The electrode 2 has a connection part (not illustrated) for an external power source, and is structured to energize the porous heat element 4 through the electrode 2 from the external power source. For example, the external power source and the electrode 2 may be connected through a cable with a crimp terminal.

Shape and size of the electrode 2 may only be those allowed for provision of the connection part for the external power source, and sufficient energization of the porous heat element 4, and are properly adjustable.

The electrode 2 preferably has a specific electric resistance of 5 to 100 μΩ·cm, which is more preferably 10 to 90 μΩ·cm.

The specific electric resistance of the electrode 2 herein is defined as a value estimated by analyzing the electrode 2 by XRD to determine the component composition, then deriving, from the element composition, the electric conductivity to be substituted into the equation below:

$$Specific electric resistance = 1 / Electric conductivity .$$

The electrode 2 is preferably formed of a fibrous material, and more preferably formed of a woven fabric made of twisted yarn of the metal fiber, or a metal fiber woven fabric.

With the electrode 2 formed of a woven fabric made of twisted yarn of the metal fiber or a metal fiber woven fabric, then the porous heat element and the electrode are less likely to separate from the joined part even if external force is applied to the sheet-like heater of this invention, for its appropriate flexibility and strength.

The woven fabric made of twisted yarn of the metal fiber or the metal fiber woven fabric, although allowed for use of fiber other than the metal fiber as the constituent, preferably formed of the metal fiber, and more preferably formed of the metal fiber only.

Now, “mainly formed of” herein means that the content accounts for 70% by mass or more. That is, the metal fiber preferably accounts for 70% by mass or more of the electrode 2. The percentage of the metal fiber contained in the electrode 2 is preferably 80% by mass or more, more preferably 90% by mass or more, even more preferably 95% by mass or more, and yet more preferably 98% by mass or more.

The woven fabric made of twisted yarn of the metal fiber, or the metal fiber woven fabric may have void remained therein.

The woven fabric made of twisted yarn of the metal fiber, or the metal fiber woven fabric may contain a material other than the metal fiber (for example, resin fiber that can function as a binder).

The metal fiber that constitutes a woven fabric made of twisted yarn of the metal fiber, or the metal fiber that constitutes a metal fiber woven fabric may have a cross section whose equivalent circle diameter is 1 to 50 μm (preferably 2 to 30 μm).

The equivalent circle diameter of the cross section of the metal fiber herein means a value determined by acquiring a 1000-fold magnified SEM image of the cross section of the electrode 2 under a scanning electron microscope (SEM), by measuring the diameter of the metal fibers on the SEM image at randomly selected 30 points, and by calculating a simple average value of the measured diameters.

With the equivalent circle diameter of the cross section of the metal fiber adjusted within the aforementioned ranges, the electrode can join with the joining aid or the porous heat element more tightly, while improving the flexibility of the sheet-like heater of this invention.

The electrode 2 preferably has a thickness of 0.5 to 3 mm. With the thickness thus adjusted, the electrode can join with the joining aid or the porous heat element more tightly, while improving the flexibility of the sheet-like heater of this invention.

The thickness of the electrode 2 is preferably adjusted so that the electrode 2 protrudes out from the outer face of the first insulating layer 6a. This facilitates connection work for the electrode 2 and the external power source, and makes various connection methods more available.

The joining aid 3 will be explained.

The sheet-like heater of this invention in Embodiment 1 has the joining aid 3 between the porous heat element 4 and the electrode 2.

As in Embodiment 1, the sheet-like heater of this invention preferably has the joining aid 3 between the electrode 2 and the porous heat element 4.

Note that the following description regarding the joining aid 3 applies not only to the joining aid 3 contained in the sheet-like heater 1a of this invention in Embodiment 1, but also to the joining aids 3 owned by the sheet-like heaters of this invention in other Embodiments described later.

Material for the joining aid 3 is not specifically limited so far as it is electroconductive, and may typically be Cu (copper), Al (aluminum), Ni (nickel), nichrome, carbon, Fe (iron) or Cr (chromium). Stainless steel is preferred.

Material for the joining aid 3 is properly selected while considering joining strength and easiness of joining between the electrode 2 and the porous heat element 4, as well as the flexibility or the like of the sheet-like heater of this invention.

The joining aid 3 may typically be metal foil, sheet-like metal mesh, metal fiber nonwoven fabric, metal fiber woven fabric, linear metal fiber, or tape-like metal fiber.

More specifically, the metal mesh is exemplified by a 200- to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The joining aid 3 is preferably the metal foil, and more preferably a stainless steel foil. The joining aid 3 in the form of metal foil facilitates weld-joining of the joining aid 3 with the electrode 2 and the porous heat element 4.

In a case where both the electrode 2 and the porous heat element 4 are formed of stainless steel, use of the joining aid 3 again formed of stainless steel will make it easier to form the joined part 7.

With the electrode 2, the porous heat element 4 and the joining aid 3, all formed of stainless steel of the same composition, the joined part 7 will be more easily formed.

In a case where the electrode 2 and the porous heat element 4 are formed of stainless steel, use of a stainless steel foil for the joining aid 3 will make it more easier to form the joined part 7.

With the electrode 2, the porous heat element 4, and the joining aid 3 in the form of stainless steel foil, all formed of stainless steel of the same composition, the joined part 7 will be more easily formed. In this case, even a small joined part 7 can easily achieve a necessary joining strength among the electrode 2 and the joining aid 3 and the porous heat element 4, thereby enhancing the flexibility of the sheet-like heater 1 of this invention.

In an exemplary case where the electrode 2 is made of copper, and the porous heat element 4 is made of stainless steel, the joining aid 3 is preferably made of a nickel alloy.

Although the shape and size of the joining aid 3 are properly adjustable, the area of the main face of the joining aid 3 opposed to the electrode 2 is preferably equal to or larger than the area of the main face of the electrode 2 opposed to the joining aid 3, since this makes it possible to form one or more joined parts 7, without paying special attention to the layout of the joining aid 3.

The joining aid 3 preferably has a specific electric resistance of 5 to 100 μΩ·cm, which is more preferably 10 to 90 μΩ·cm.

Note the specific electric resistance of the joining aid 3 herein is determined in accordance with JIS K7194.

The joining aid 3 preferably has a thickness of 10 to 100 μm.

With the thickness adjusted to 10 to 100 μm, the joining aid 3 will easily achieve a necessary joining strength between the porous heat element 4 and the electrode 2, while keeping the flexibility of the sheet-like heater 1 of this invention. While keeping the flexibility of the sheet-like heater 1 of this invention, a necessary level of the joining strength among the porous heat element 4, the joining aid 3 and the electrode 2 may be achieved.

The first insulating layer 6a and the second insulating layer 6b will be explained.

The sheet-like heater of this invention preferably has the first insulating layer 6a and/or the second insulating layer 6b.

The sheet-like heater of this invention preferably has the first insulating layer 6a, the porous heat element 4, and the second insulating layer 6b stacked therein in this order, as in Embodiment 1.

Note that the following description regarding the first insulating layer 6a and the second insulating layer 6b applies not only to the first insulating layer 6a and the second insulating layer 6b contained in the sheet-like heater 1a of this invention in Embodiment 1, but also to the first insulating layers and the second insulating layers that can be owned by the sheet-like heaters of this invention that involve other Embodiments described later.

The first insulating layer 6a and the second insulating layer 6b play a role of electrically isolating the porous heat element 4 from other components, and are therefore preferably sheet-like components formed of a material with high insulating performance.

Any of the insulating layers that is placed closer to a surface of an object to be heated, when the sheet-like heater 1a of this invention is placed on the surface of the object to be heated, preferably has heat conductivity as well as insulating property.

The first insulating layer 6a and the second insulating layer 6b may preferably be formed, for example, of PET (polyethylene terephthalate), PI (polyimide), PP (polypropylene), PE (polyethylene), PEN (polyethylene naphthalate), TAC (triacetyl cellulose), silicone resin, ceramic or the like, since they have high insulating property. Among them, the first insulating layer 6a and/or the second insulating layer 6b formed of PI (polyimide) are preferably used for their excellent heat resistance and insulating property.

The thickness of each of the first insulating layer 6a and the second insulating layer 6b is preferably, but not specifically limited to, 50 to 700 μm, which is more preferably 100 to 600 μm, and even more preferably 200 to 500 μm.

Shape and size of the first insulating layer 6a and the second insulating layer 6b are not specifically limited. Considering that the first insulating layer 6a and the second insulating layer 6b play a role of electrically isolating the porous heat element 4 from the other components, the size of the main faces of the first insulating layer 6a and second insulating layer 6b is usually equal to or larger than the main face of the porous heat element 4.

In the sheet-like heater of this invention having the first insulating layer 6a, the porous heat element 4, and second insulating layer 6b stacked in this order as in Embodiment 1, the main faces of the first insulating layer 6a and the porous heat element 4, and, the main faces of the porous heat element 4 and the second insulating layer 6b, may be joined typically with use of an adhesive.

Some other layer may be interposed between the first insulating layer 6a and the porous heat element 4, or between the porous heat element 4 and the second insulating layer 6b.

The first insulating layer 6a and the second insulating layer 6b may be formed of the same material, or different materials.

The first insulating layer 6a and the second insulating layer 6b may have the same thickness, or different thicknesses.

In the sheet-like heater 1a of this invention, at least a part of the electrode 2 is not covered with the first insulating layer 6a and the second insulating layer 6b. In the sheet-like heater 1a of this invention in Embodiment 1, the electrode 2 is not covered with the first insulating layer 6a, and instead, the outer face of the electrode 2 is exposed as viewed from the outer face side of the insulating layer 6a. That is, the first insulating layer 6a has an opening formed therein, so as to expose therein the outer face of the electrode 2.

The sheet-like heater 1a of this invention in Embodiment 1 has the electrode 2 on one main face of the sheet-like porous heat element 4, while placing the joining aid 3 in between.

The sheet-like heater of this invention in Embodiment 1 may have other component between the electrode 2 and the joining aid 3, or between the joining aid 3 and the porous heat element 4, so far as formation of the joined part 7 is not interfered.

The thickness of the sheet-like heater of this invention is preferably 150 to 500 μm, and more preferably 300 to 400 μm.

### Embodiment 2

Embodiment 2 of the sheet-like heater of this invention will be explained while referring to the attached drawings.

Embodiment 2 relates to a sheet-like heater having a sheet-like porous heat element, the sheet-like heater having:
a first insulating layer;
the sheet-like porous heat element; and
a second insulating layer stacked in this order,
wherein,
an electrode is present on at least one main face of the porous heat element,
further having a joining aid between the porous heat element and the electrode,
at least a part of the electrode is not covered with the first insulating layer and the second insulating layer,
having a reinforcing member on the main face of the porous heat element on the side having no electrode present thereon, and
having a joined part formed of the reinforcing member, the porous heat element, the joining aid and the electrode which are at least partially melted under heating and then allowed to solidify, whereby the joined part electrically connects the reinforcing member, the porous heat element, the joining aid and the electrode.

That is, Embodiment 2 relates to the sheet-like heater of this invention, which is a preferred mode further having the first insulating layer, the second insulating layer, the joining aid and the reinforcing member.

The joined part in this case is formed as a result of fusion of at least a part of the reinforcing member, at least a part of the porous heat element, at least a part of the joining aid, and at least a part of the electrode, followed by solidification.

The reinforcing member, the porous heat element, the joining aid, and the electrode are electrically connected through the joined part.

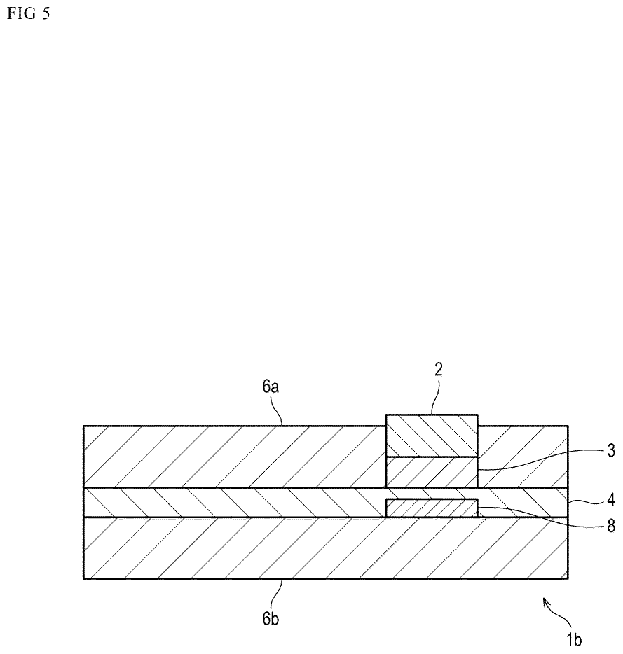

A drawing (schematic drawing) of the sheet-like heater 1b of this invention in Embodiment 2, viewed in a direction of a perpendicular line on the main face thereof, will be same as FIG. 1. A cross-sectional view (schematic drawing) of the sheet-like heater 1b of this invention in Embodiment 2, taken along a direction parallel to a perpendicular line on the main face thereof at a place that corresponds to line A-A in FIG. 1, is given by FIG. 5.

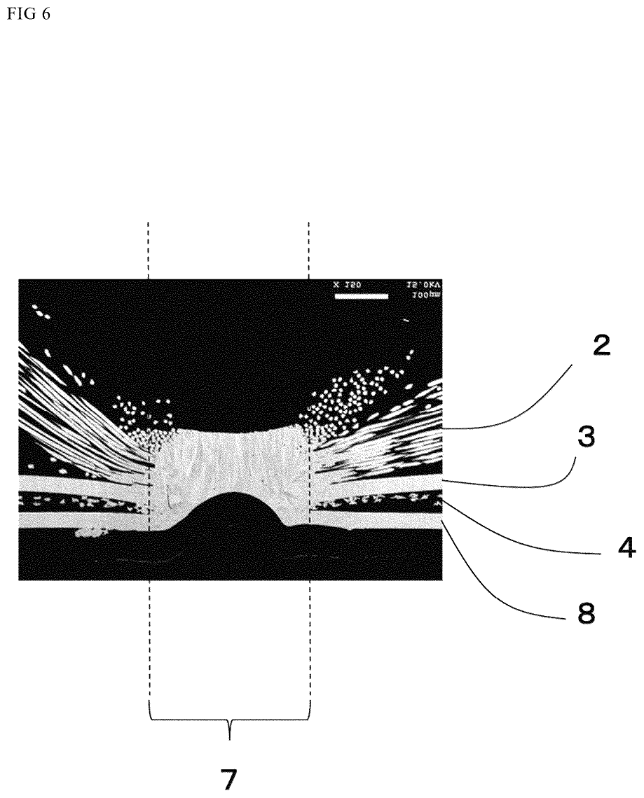

FIG. 6 is a SEM image of a joined part and the periphery of the sheet-like heater 1b of this invention in Embodiment 2, obtained by observing a cross section taken along a direction parallel to a perpendicular line on the main face of the sheet-like heater 1b of this invention, under a scanning electron microscope (SEM).

The electrode 2 used herein was a tape-like metal fiber (tape B W16, from Nippon Seisen Co., Ltd.); each of the joining aid 3 and the reinforcing member 8 used herein was a 30-μm thick stainless steel foil; and the porous heat element 4 used herein was a stainless steel fiber sheet (Tommy Filec SS, from Tomoegawa Corporation).

The reinforcing member 8, the porous heat element 4, the joining aid 3 and the electrode 2 were stacked in this order, and the stack was spot-welded from the top face of the electrode 2, to form the joined part 7.

FIG. 6 helps to understand that a part of the electrode 2, a part of the joining aid 3, a part of the porous heat element 4, and a part of the reinforcing member 8 fused and then solidified, to form the joined part 7.

The presence of the reinforcing member 8 enabled formation of the joined part 7 having a thickness of 150 μm or larger. The joined part 7, thus having a sufficient thickness, is considered to be less breakable, even if external force is applied to the sheet-like heater 1b of this invention.

The reinforcing member 8 will be explained.

The sheet-like heater of this invention in Embodiment 2 has the reinforcing member 8, on the main face of the porous heat element 4 on the side having no electrode 2 present thereon.

The sheet-like heater of this invention preferably has the reinforcing member 8 on the main face of the porous heat element 4 on the side having no electrode 2 present thereon, as in Embodiment 2.

Note that the following description regarding the reinforcing member 8 applies not only to the reinforcing member 8 contained in the sheet-like heater 1b of this invention in Embodiment 2, but also to the reinforcing member 8 that can be owned by the sheet-like heaters of this invention that involve other Embodiments described later.

Material for the reinforcing member 8 is not specifically limited, to which either inorganic or organic substance is applicable, so long as it is flexible and durable to temperature (heating temperature) under heat generated by the porous heat element 4 contained in the sheet-like heater 1b of this invention.

Note, however, Embodiment 2 relates to a mode where the reinforcing member 8 is formed of metal which is one of the inorganic substance.

Since the reinforcing member 8 in Embodiment 2 is formed of metal, so that the joined part 7 owned by the sheet-like heater 1b of this invention in Embodiment 2 is formed of at least a part of reinforcing member, at least a part of the porous heat element, at least a part of the joining aid, and at least a part of the electrode which were fused and then solidified. The reinforcing member, the porous heat element, the joining aid, and the electrode are electrically connected through the joined part.

On the other hand, in a mode where the reinforcing member 8 is not formed of metal, the joined part owned by the sheet-like heater of this invention of this mode is formed of at least a part of the porous heat element, at least a part of the joining aid, and at least a part of the electrode which were fused and then solidified.

Material for the reinforcing member 8 may be same as, or different from the joining aid 3.

The material for the reinforcing member 8 is preferably the same metal for the porous heat element 4, more preferably the same metal for the porous heat element 4 and the joining aid 3, and even more preferably the same metal for the porous heat element 4, the joining aid 3 and the electrode 2.

The material for the reinforcing member 8 is more preferably stainless steel (SUS304, SUS316 or SUS316L, for example).

The reinforcing member 8 may be embodied typically in the form of metal foil, sheet-like metal mesh, metal fiber nonwoven fabric, metal fiber woven fabric, linear metal fiber, or tape-like metal fiber.

More specifically, the metal mesh is exemplified by a 200- to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The reinforcing member 8 is preferably the metal foil, and more preferably a stainless steel foil. The reinforcing member 8 in the form of metal foil can fill the voids of the porous heat element 4 to strengthen the joined part 7, when weld-joining a stack of the electrode 2, the joining aid 3, the porous heat element 4, and the reinforcing member 8.

The presence of the reinforcing member 8 can make the porous heat element and the electrode less likely to separate from the joined part, even if external force is applied to the sheet-like heater.

A part of the reinforcing member 8 preferably, but not always necessarily, forms the joined part 7.

Embodiment 2 relates to a mode where a part of the reinforcing member 8 forms the joined part 7.

It is more preferred that at least a part of the electrode 2, at least a part of the joining aid 3, at least a part of the porous heat element 4, and at least a part of the reinforcing member 8 are integrated to form the joined part.

Size and shape of the reinforcing member 8 are not specifically limited.

The area of the main face of the reinforcing member 8 opposed to the electrode 2 is preferably equal to or larger than the area of the main face of the electrode 2 opposed to the reinforcing member 8. In a case where the joining aid 3 is present like in the sheet-like heater 1b of this invention, the area of the main face of the reinforcing member 8 opposed to the joining aid 3 is preferably equal to or larger than the area of the main face of the joining aid 3 opposed to the reinforcing member 8. This is because one or more joined parts 7 may be formed without paying special attention to the layout of the reinforcing members 8, and
because more strengthened joined part 7 may be formed.

The reinforcing member 8 preferably has a thickness of 10 to 100 km. With the thickness of the reinforcing member 8 adjusted to 10 to 100 μm, more strengthened joined part 7 will be formed easily.

### Embodiment 3

Embodiment 3 of the sheet-like heater of this invention will be explained while referring to the attached drawings.

Embodiment 3 relates to a sheet-like heater having a sheet-like porous heat element, the sheet-like heater having:
a first insulating layer;
the sheet-like porous heat element; and
a second insulating layer stacked in this order,
wherein,
an electrode is present on at least one main face of the porous heat element,
further having a joining aid between the porous heat element and the electrode,
at least a part of the electrode is not covered with the first insulating layer and the second insulating layer,
having a protecting member on the main face on the outer face side of the electrode, and
having a joined part formed of the porous heat element, the joining aid, the electrode and the protecting member, which are at least partially melted under heating and then allowed to solidify, whereby the joined part electrically connects the porous heat element, the joining aid, the electrode and the protecting member.

That is, Embodiment 3 relates to the sheet-like heater of this invention, which is a preferred mode further having the first insulating layer, the second insulating layer, the joining aid and the protecting member.

The joined part in this case is formed as a result of fusion of at least a part of the porous heat element, at least a part of the joining aid, at least a part of the electrode, and at least a part of the protecting member, followed by solidification.

The porous heat element, the joining aid, the electrode, and the protecting member are electrically connected through the joined part.

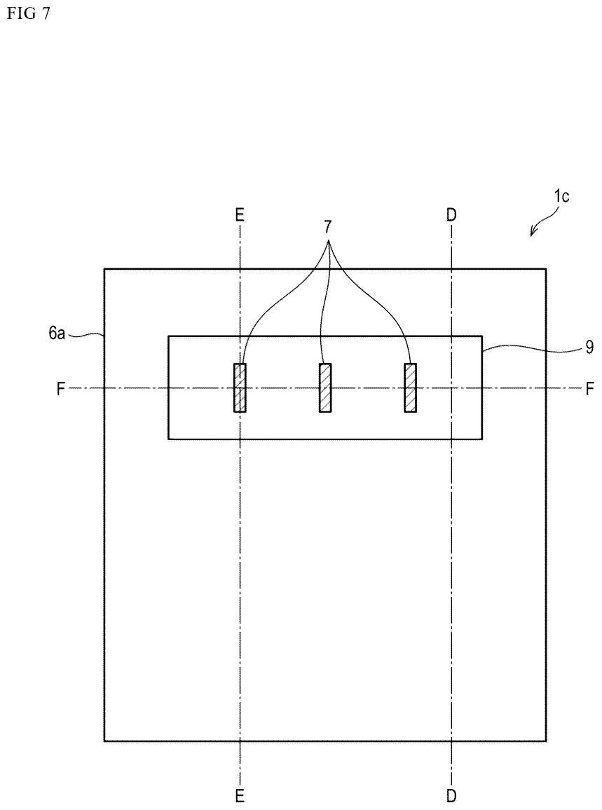

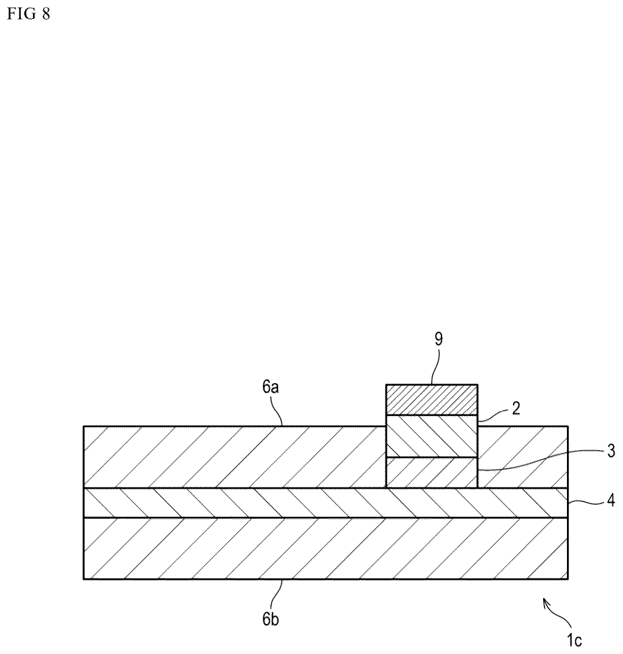

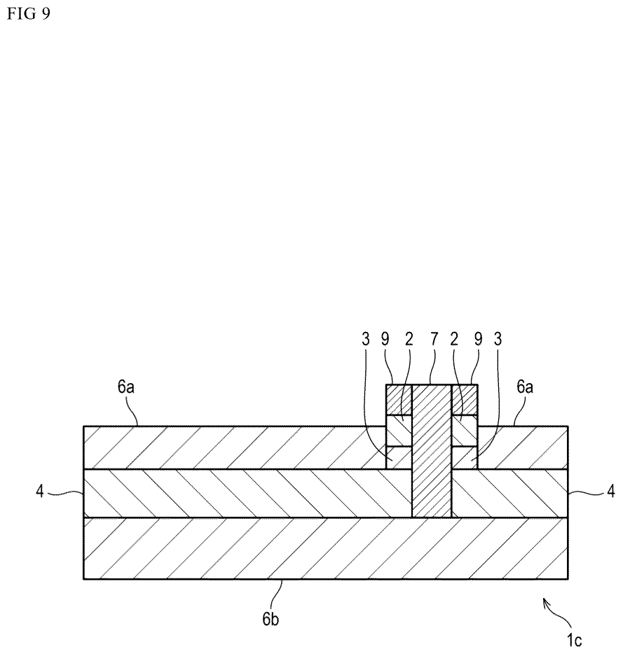

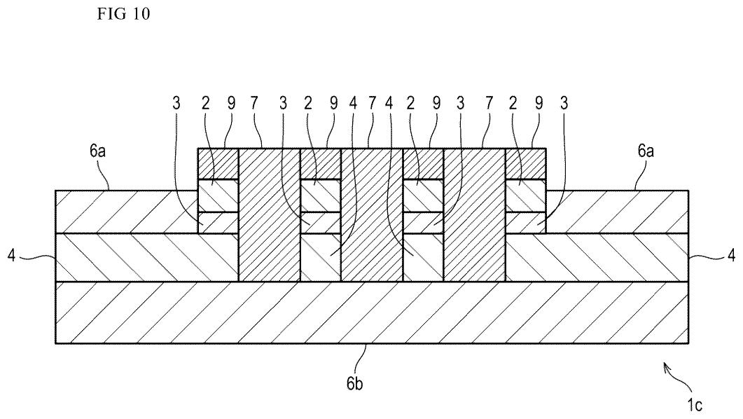

FIG. 7 is a drawing (schematic drawing) illustrating the sheet-like heater 1c of this invention in Embodiment 3, viewed in a direction of a perpendicular line on the main face thereof. FIG. 8 is a cross-sectional view (schematic drawing) taken along line D-D in FIG. 7; FIG. 9 is a cross-sectional view (schematic drawing) taken along line E-E in FIG. 7; and FIG. 10 is a cross-sectional view (schematic drawing) taken along line F-F in FIG. 7. All of FIGS. 8 to 10 illustrate cross sections taken in directions parallel to the perpendicular line on the main face of the sheet-like heater 1c of this invention.

As illustrated in FIGS. 7 to 10, the sheet-like heater 1c of this invention in Embodiment 3 has a protecting member 9 on the outer side of the electrode 2, that is on the main face of the electrode 2 on the side away from the joining aid 3.

The protecting member 9 is provided to protect the electrode 2. With the protecting member 9 thus provided, the electrode 2 will be less likely to degrade after long-term use of the sheet-like heater 1c of this invention, and will tend to be tightly joined to the joined part 7.

The presence of the protecting member 9 enables protection of the outer face of the electrode 2, even under external force applied to the sheet-like heater 1c of this invention, whereby the electrode 2, the joining aid 3, and the porous heat element 4 will more easily keep the joining with the joined part 7.

The protecting member 9 is not specifically limited so far as it can protect the electrode 2.

Material for the protecting member 9 may be insulating material, conductive material or semiconductor, without special limitation.

Note, however, that the protecting member 9 in the sheet-like heater 1c of this invention in Embodiment 3 is formed of metal.

The material for the protecting member 9 is preferably metal, and more preferably stainless steel (SUS304, SUS316 or SUS316L, for example).

The protecting member 9 may typically be metal foil, sheet-like metal mesh, metal fiber nonwoven fabric, metal fiber woven fabric, linear metal fiber, or tape-like metal fiber.

More specifically, the metal mesh is exemplified by a 200- to 500-mesh metal mesh.

The metal fiber nonwoven fabric is exemplified by a 1500 g/m² stainless steel fiber nonwoven fabric (SUS316L needle punch web, from Nikko Techno, Ltd.).

The metal fiber woven fabric is exemplified by SUS cloth (Naslon Cloth A, from Nippon Seisen Co., Ltd.).

The linear metal fiber is exemplified by filament yarn (Naslon 12-2000/3, from Nippon Seisen Co., Ltd.).

The tape-like metal fiber is exemplified by SUS tape (Naslon Tape B W16, from Nippon Seisen Co., Ltd.).

The protecting member 9 is preferably the metal foil, and more preferably a stainless steel foil.

The electrode 2, when joined with the protecting member 9 formed of a conductive material, will have increased electric connection points or electric connection area with the porous heat element 4, and this demonstrates an effect of stabilizing electric connection between the electrode 2 and the porous heat element 4. With the protecting member 9 thus provided, the electrode 2 will be made not only connectable directly with the joining aid 3, but also connectable via the protecting member 9 with the joining aid 3.

The protecting member 9 may be joined with the electrode 2 or not, and is preferably joined with the electrode 2.

Although size of the protecting member 9 is not specifically limited, the main face thereof is preferably equivalent to, or larger than the main face of the electrode 2.

Shape of the protecting member 9 is not specifically limited.

The protecting member 9 preferably has a thickness of 10 to 100 μm.

### Embodiment 4

Embodiment 4 of the sheet-like heater of this invention will be explained while referring to the attached drawing.

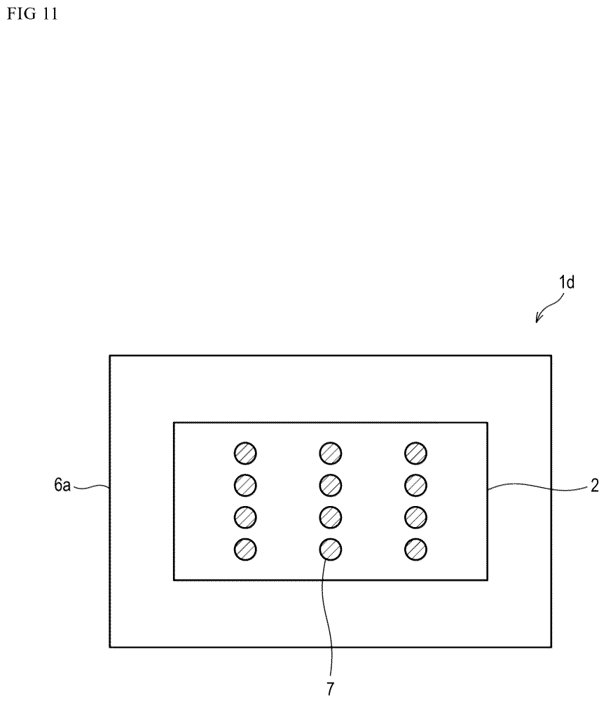

FIG. 11 is a drawing (schematic drawing) illustrating a sheet-like heater 1d of this invention in Embodiment 4, viewed in a direction of a perpendicular line on the main face thereof.

Embodiment 4 relates to a mode similar to Embodiment 1 or Embodiment 2, which is all the same with Embodiment 1 or Embodiment 2 except for the joined part 7.

The sheet-like heater 1d of this invention in Embodiment 4 relates to a mode where twelve dot-like joined parts 7 are distributed.

### Embodiment 5

The sheet-like heater of this invention in Embodiment 5 will be explained while referring to the attached drawing.

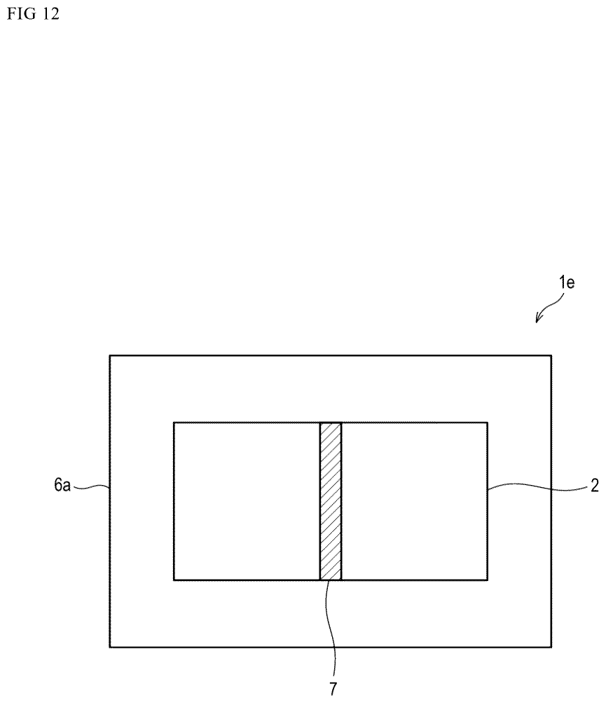

FIG. 12 is a drawing (schematic drawing) illustrating a sheet-like heater 1e of this invention in Embodiment 5, viewed in a direction of a perpendicular line on the main face thereof.

Embodiment 5 relates to a mode similar to Embodiment 1 or Embodiment 2, which is all the same with Embodiment 1 or Embodiment 2 except for the joined part 7.

The sheet-like heater 1e of this invention in Embodiment 5 relates to a mode having one linear joined part 7.

### Embodiment 6

The sheet-like heater of this invention in Embodiment 6 will be explained while referring to the attached drawing.

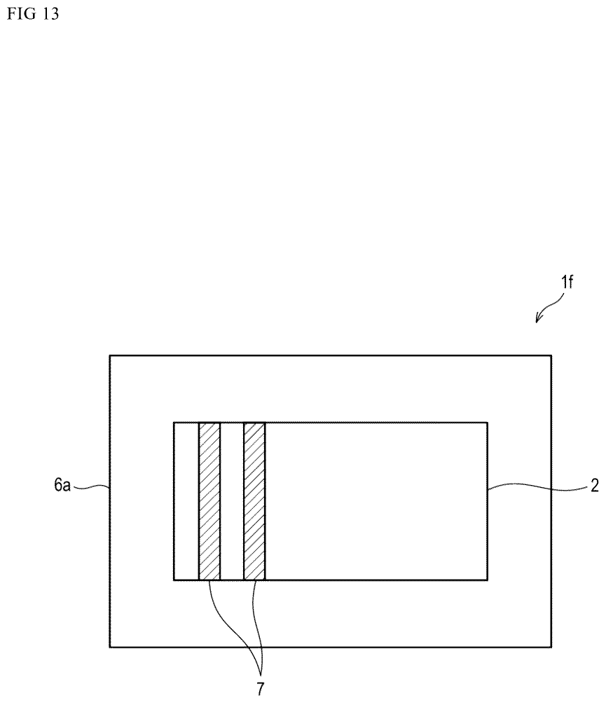

FIG. 13 is a drawing (schematic drawing) illustrating a sheet-like heater 1f of this invention in Embodiment 6, viewed in a direction of a perpendicular line on the main face thereof.

Embodiment 6 relates to a mode similar to Embodiment 1 or Embodiment 2, which is all the same with Embodiment 1 or Embodiment 2 except for the joined part 7.

The sheet-like heater 1f of this invention in Embodiment 6 relates to a mode having two linear joined parts 7. The joined parts 7 in Embodiment 6 are localized.

### <<Manufacturing Method>>

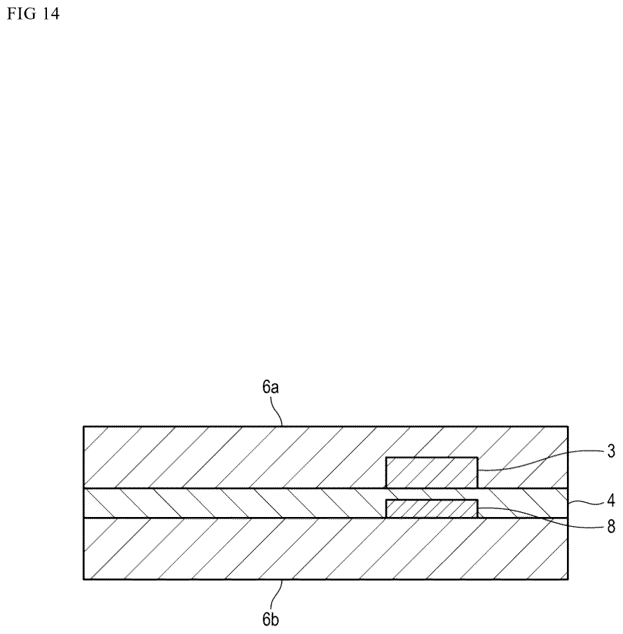

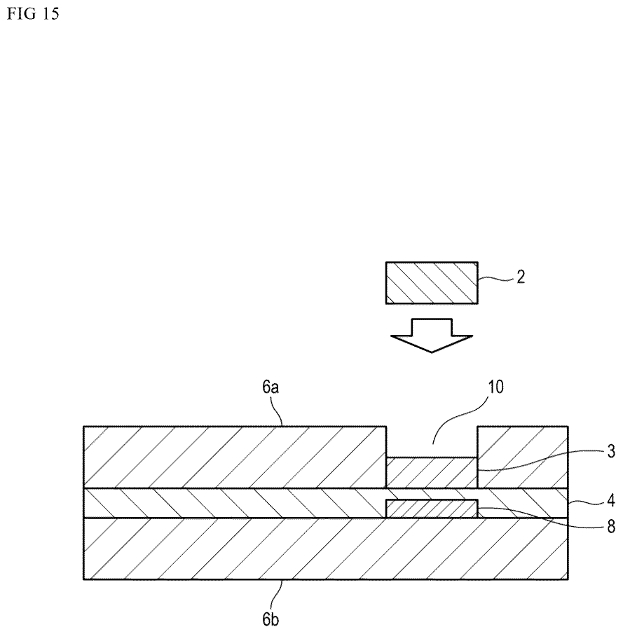

Manufacturing method of the sheet-like heater of this invention (referred to as manufacturing method of this invention, hereinafter) will be explained while referring to FIGS. 14 and 15.

The manufacturing method of this invention explained below is an example of a preferred manufacturing method. The sheet-like heater of this invention is not limited to the one manufactured by the manufacturing method of this invention described below.

FIGS. 14 and 15 are drawings explaining the method for manufacturing the sheet-like heater 1b in Embodiment 2.

First, prepared is a base in which the first insulating layer 6a, the joining aid 3, the porous heat element 4, the reinforcing member 8, and the second insulating layer 6b are stacked and the individual layers are tightly contacted (FIG. 14). The individual layers may be tightly contacted typically with use of an adhesive.

Next, a part of the first insulating layer 6a is cut off typically with use of a cutter to form an opening 10, in which the joining aid 3 exposes (FIG. 15).

Next, the electrode 2 is placed so as to overlap with the joining aid 3, and is then joined to the joining aid 3, whereby the sheet-like heater 1b of this invention is obtained. Means for joining may be any of means known by those skilled in the art, which is typically welding processing.

### INDUSTRIAL APPLICABILITY

The sheet-like heater of this invention is typically applicable to pipe, film forming apparatus, hot air generator or the like.

1. A sheet-like heater having a sheet-like porous heat element, the sheet-like heater comprising:
an electrode present on at least one main face of the porous heat element; and
at least one joined part formed of the porous heat element and the electrode which are at least partially melted under heating and then allowed to solidify, whereby the joined part electrically connects the porous heat element and the electrode.

2. The sheet-like heater according to claim 1, comprising:
a first insulating layer;
the sheet-like porous heat element; and
a second insulating layer, which are stacked in this order, and
at least a part of the electrode is not covered with the first insulating layer and the second insulating layer.

3. The sheet-like heater according to claim 1, further comprising a joining aid between the porous heat element and the electrode, wherein
the joined part is formed of the porous heat element, the joining aid and the electrode which are at least partially melted under heating and then allowed to solidify,
whereby the joined part electrically connects the porous heat element, the joining aid and the electrode.

4. The sheet-like heater according to claim 3, further comprising a reinforcing member on the main face of the porous heat element on the side having no electrode present thereon, wherein
the joined part is formed of the reinforcing member, the porous heat element, the joining aid and the electrode which are at least partially melted under heating and then allowed to solidify, whereby the joined part electrically connects the reinforcing member,
the porous heat element, the joining aid and the electrode.

5. The sheet-like heater according to claim 1, further comprising a reinforcing member on the main face of the porous heat element on the side having no electrode present thereon, wherein
the joined part is formed of the reinforcing member, the porous heat element and the electrode which are at least partially melted under heating and then allowed to solidify.

6. The sheet-like heater according to claim 1, having a plurality of the joined parts per electrode.

7. The sheet-like heater according to claim 1, wherein the joined part has a dot shape and/or a line shape, when the main face is viewed from the side the electrode is present.

8. The sheet-like heater according to claim 1, wherein the electrode and the porous heat element are formed of the same kind of metal.

9. The sheet-like heater according to claim 1, wherein the electrode and the porous heat element are formed of different kinds of metal.

10. The sheet-like heater according to claim 1, wherein the electrode contains a metal fiber.

11. The sheet-like heater according to claim 1, wherein the porous heat element contains a metal fiber.

12. The sheet-like heater according to claim 2, further comprising a joining aid between the porous heat element and the electrode, wherein
the joined part is formed of the porous heat element, the joining aid and the electrode which are at least partially melted under heating and then allowed to solidify, whereby the joined part electrically connects the porous heat element, the joining aid and the electrode.

13. The sheet-like heater according to claim 2, further comprising a reinforcing member on the main face of the porous heat element on the side having no electrode present thereon, wherein
the joined part is formed of the reinforcing member, the porous heat element and the electrode which are at least partially melted under heating and then allowed to solidify.

14. The sheet-like heater according to claim 2, having a plurality of the joined parts per electrode.

15. The sheet-like heater according to claim 2, wherein the joined part has a dot shape and/or a line shape, when the main face is viewed from the side the electrode is present.

16. The sheet-like heater according to claim 6, wherein the joined part has a dot shape and/or a line shape, when the main face is viewed from the side the electrode is present.
